(19) United States
(12) Patent Application Publication
(10) Pub. No.: US 2007/0019180 A1
(43) Pub. Date: Jan. 25, 2007

(54) Image-forming device having brush/drum processor

(75) Inventors: Ralph L. Piccinino JR., Rush, NY (US); Daniel C. Maslanka, Naples, NY (US); Andrew Ciaschi, Pittsford, NY (US); Margaret D. Steele, Webster, NY (US); Paul S. Taylor, Hamlin, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/184,756

(22) Filed: Jul. 19, 2005

(51) Int. Cl. G03B 27/00

(52) U.S. Cl. 355/406; 355/40; 355/47

(57) ABSTRACT

An image-forming device includes a processing member in the form of a brush/drum processor. The processing member includes a rotatable vacuum drum with a surface that is adapted to receive an exposed photosensitive medium. Vacuum applied to the drum is effective to hold a medium on the drum. The processing member also includes a pad member that faces the outer surface of the drum. The pad member includes micro-members that resemble a brush and are adapted to contact the media while the media is held on the drum. The pad member can be moved in an oscillating manner to cause the micro-members to contact the imaging surface of the media held on the drum with a pressure that is sufficient to rupture microcapsules in the media.

### CROSS REFERENCE TO RELATED APPLICATIONS

Reference is made to commonly-assigned U.S. patent applications: Ser. No. 10/722,248 filed Nov. 25, 2003, entitled AN IMAGE FORMING DEVICE HAVING A BRUSH TYPE PROCESSING MEMBER to Alphonse D. Camp et al.; Ser. No. 10/851,886 filed May 21, 2004, entitled AN IMAGE FORMING DEVICE HAVING A BELT TYPE PROCESSING MEMBER WITH MICRO-FEATURES to Zhanjun Gao et al. and Ser. No. 10/874,888 filed Jun. 23, 2004, entitled AN IMAGE FORMING DEVICE AND AN EXPOSURE MEMBER FOR THE DEVICE to Alphonse D. Camp.

### FIELD OF THE INVENTION

The present invention relates to an image-forming device with a brush/drum-type processing member for processing photosensitive media, wherein the photosensitive media includes a plurality of microcapsules that encapsulate imaging material such as coloring material.

### BACKGROUND OF THE INVENTION

Image-forming devices are known in which media having a layer of microcapsules containing a chromogenic material and a photohardenable or photosoftenable composition, and a developer, which may be in the same or a separate layer from the microcapsules, is image-wise exposed. In these devices, the microcapsules are ruptured, and an image is produced by the differential reaction of the chromogenic material and the developer. More specifically, in these image-forming devices, after exposure and rupture of the microcapsules, the ruptured microcapsules release a color-forming agent, whereupon the developer material reacts with the color-forming agent to form an image. The image formed can be viewed through a transparent support or a protective overcoat against a reflective white support as is taught in, for example, U.S. Pat. No. 5,783,353 and U.S. Publication No. 2002/0045121 A1. Typically, the microcapsules will include three sets of microcapsules sensitive respectively to red, green and blue light and containing cyan, magenta and yellow color formers, respectively, as taught in U.S. Pat. No. 4,772,541. Preferably a direct digital transmission imaging technique is employed using a modulated LED print head to expose the microcapsules.

Conventional arrangements for developing the image formed by exposure in these image-forming devices include using spring-loaded balls, micro wheels, micro rollers or rolling pins, and heat from a heat source is applied after this development step to accelerate development.

The photohardenable composition in at least one and possibly all three sets of microcapsules can be sensitized by a photo-initiator such as a cationic dye-borate complex as described in, for example, U.S. Pat. Nos. 4,772,541; 4,772,530; 4,800,149; 4,842,980; 4,865,942; 5,057,393; 5,100,755 and 5,783,353.

The above describes micro-encapsulation technology that combines micro-encapsulation with photo polymerization into a photographic coating to produce a continuous tone, digital imaging member. With regard to the media used in this technology, a substrate is coated with millions of light sensitive microcapsules, which contain either cyan, magenta or yellow image forming dyes (in leuco form). The microcapsule further comprises a monomer and the appropriate cyan, magenta or yellow photo initiator that absorb red, green or blue light respectively. Exposure to light, after the induction period is reached, induces polymerization.

When exposure is made, the photo-initiator absorbs light and initiates a polymerization reaction, converting the internal fluid (monomer) into polymer, which binds or traps leucodye from escaping when pressure is applied.

With no exposure, microcapsules remain soft and are easily broken, permitting all of the contained dye to be expelled into a developer containing binder and developed which produces the maximum color available. With increasing exposure, an analog or continuous tone response occurs until the microcapsules are completely hardened, to thereby prevent any dye from escaping when pressure is applied.

Conventionally, as describe above, in order to develop the image, pressure is uniformly applied across the image. As a final fixing step, heat is applied to accelerate color development and to react all un-reacted liquid from the microcapsules. This heating step also serves to assist in the development of available leucodye for improved image stability. Generally, pressure ruptured capsules (unhardened) expel luecodye into the developer matrix.

Small compact low cost printers typically employed micro-wheels or balls backed by springs and operate in a scanning stylus fashion by transversing the media. This allowed for low cost and relatively low spring force due to the small surface area that the ball or micro wheel (typically 2 to 3 mm diameter) contacted on the media. The disadvantage of this method was that the processing pitch required to assure uniform development needs to be (approximately 1 mm for a 3/16″ diameter ball) which results in slow processing times for a typical print image format (4×6 inch). Ganging multiple ball stylus or micro wheels adds cost, and increases the possibility of processing failure due to debris caught under a ball surface.

Conventional high speed processing involved line processing utilizing large crushing rollers. To ensure the high pressure, (psi) required, these rollers tended to be large to minimize deflection. However, these large rollers were costly, heavy, and require high spring loading. Also, the extensibility of this method is limited as larger rollers (and spring loads) are required as media size increases.

Recent developments in media design (or the imaging member) as described in co-pending U.S. Publication No. 2005/0084783 have changed the prior art structure of the imaging member to the point where the aforementioned means of processing may no longer be robust. The use of a substantially non-compressible top clear polymer film layer and a rigid opaque backing layer which serves to contain the image forming layer of conventional media presented a processing position whereby balls, micro wheels or rollers could be used without processing artifacts such as scratch, banding, or dimensional or surface deformation. In addition, the non-compressibility of this prior art structure provided more tolerance to processing conditions. The recent imaging member embodiment as described in the above-mentioned co-pending patent application, replaces the top and bottom structures of the media with highly elastic and compressible materials (gel SOC) (super over coat or top most clear gel comprising layer) and paper support. The media as described in the above-mentioned co-pending application may no longer survive these means of processing in a robust fashion where pressure is applied by a roller or ball. This is due to the fact that in the imaging member described in the co-pending application, the polyolefin paper backing that is used as fiber base substrates (cellulose fiber) present non uniform density, and the high compression forces required for processing in the conventional arrangements may make an “image” of the fiber pattern in the print, thus making the print corrupt.

It would be advantageous to provide a means or method of processing that did not invoke present methods utilizing high compression forces, to provide a high quality image by improving the tonal scale development and density minimum formation of the imaging member. It would also be advantageous to provide for a processing apparatus that can reduce processing time by having the entire media in contact with a processing member at once.

As mentioned, the need to provide a means of processing that will facilitate the use of the recently designed imaging member is needed. In addition, a processing means that would use plain paper as a substrate would be highly desired. Further, it would be advantageous to provide a means of processing that is low in cost, is fully extensible, and is mechanically simple and robust.

### SUMMARY OF THE INVENTION

The present invention provides for an image-forming device and method that addresses the issues noted above. The image-forming device of the present invention offers the advantages of both types of prior art, i.e., low spring load and fast printing speed.

The present invention addresses the above noted drawbacks by providing for an image-forming device, which comprises a vacuum drum-type processing member with an oscillating pad member that includes a plurality of micro-members or brushes thereon.

The micro-members or brushes on the pad member provides for a compliant surface, which can be non-uniform, is self-correcting for unintentional media thickness variations within a print area, and employs shear-like forces more so than compression forces or a combination thereof for development. The use of the micro-members restricts the processing development to the image-forming layer of the media, leaving both the top-most clear gel comprising layer intact and without scratches. Further, the micro-members do not invade the bottom-most backing layer of the media and thus avoids pattern read out of low cost supports.

The image-forming device of the present invention including the brush/drum type processor is fully extensible for all printer applications, defines a small foot-print and is low cost. The composition of the micro members of the present invention can be varied; for example, where a polymer can be used since it provides a soft contact surface, elasticity, and resiliency, however, any natural or synthetic material meeting these criteria can be employed as the micro-members or brush.

In a further feature of the invention, post heat rollers are provided downstream of a processing section to fix the image on the media.

The present invention therefore provides for an image-forming device that comprises an imaging member adapted to expose a photosensitive medium to form a latent image on the photosensitive medium, with the photosensitive medium comprising a plurality of microcapsules which encapsulate imaging material; and a processing member adapted to develop the latent image. The processing member comprises a rotatable vacuum drum having an outer surface adapted to receive the exposed photosensitive medium, with the outer surface of the drum comprising a plurality of apertures for a passage of a vacuum force there-through to hold the medium on the outer surface of the drum during processing; and a pad member having a processing surface that faces the outer surface of the vacuum drum. The processing surface of the pad member comprising a plurality of micro-members that are adapted to contact a surface of the photosensitive medium as the photosensitive medium held on the outer surface of the drum by the vacuum force is conveyed by rotation of the vacuum drum to the processing surface of the pad member.

The present invention further relates to an image forming method that comprises exposing a photosensitive medium comprising a plurality of microcapsules which encapsulate imaging material to form a latent image; conveying the medium onto an outer surface of a processing drum, with the outer surface of the processing drum comprising a plurality of apertures; applying a vacuum force to the processing drum to create a suction force through the apertures and hold the medium on the outer surface of the processing drum; and moving the processing drum to convey the medium to a processing pad having a processing surface that faces the outer surface of the processing drum, with the processing surface of the processing pad comprising a plurality of micro-members that are adapted to contact a surface of the medium when the medium is conveyed to the processing pad.

The present invention further relates to an image forming device that comprises a processing member adapted to develop a latent image on an exposed photosensitive medium, with the photosensitive medium comprising a plurality of microcapsules that encapsulate imaging material. The processing member comprises a vacuum drum adapted to hold the exposed photosensitive medium thereon through a vacuum force, and a pad member that faces the vacuum drum. The pad member comprises a plurality of micro-members that are adapted to contact a surface of the photosensitive medium with a force that is sufficient to release imaging material from the microcapsules.

The present invention further relates to an image forming method that comprises placing an exposed photosensitive medium onto a surface of a processing drum, with the photosensitive medium comprising microcapsules that encapsulate imaging material; applying a vacuum force to the processing drum to hold the medium on the surface of the processing drum; and contacting a surface of the photosensitive medium with micro-members that extend from a pad member with a force sufficient to release the imaging material from the microcapsules.

### BRIEF DESCRIPTION OF THE DRAWINGS

FIG. 1A schematically shows an image-forming device;

FIG. 1B schematically shows an example of a pressure applying system that can be used in the image-forming device of FIG. 1A;

FIG. 2 illustrates a side view of on image-forming device and specifically, a brush/drum processing member in accordance with a feature of the present invention;

FIG. 3 is a perspective view of the brush/drum processing member of FIG. 2;

FIG. 4 is a further view of the brush/drum processing member of FIG. 2; and

FIG. 5 is a further view of the brush/drum processing member of the present invention.

### DETAILED DESCRIPTION OF THE INVENTION

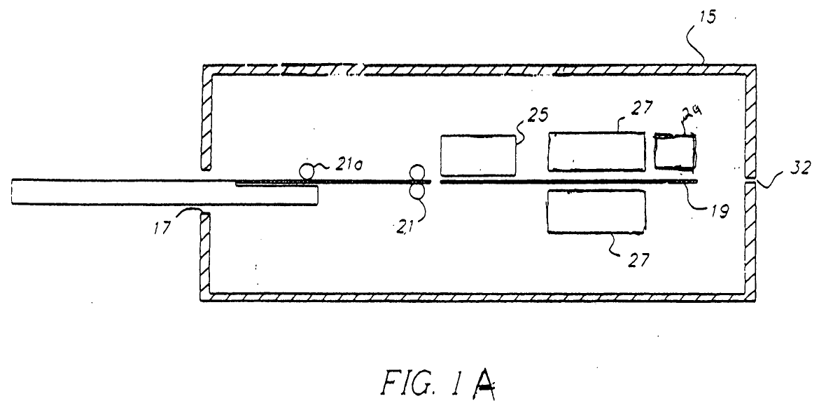

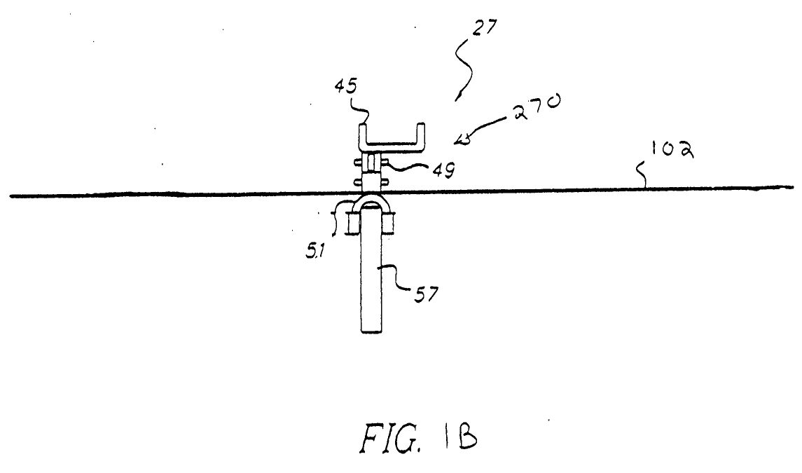

Referring now to the drawings, wherein like reference numerals represent identical or corresponding parts throughout the several views, FIG. 1A is a schematic view of an image-forming device 15 pertinent to the present invention. Image-forming device 15 could be, for example, a printer that includes an opening 17 that is adapted to receive a cartridge containing photosensitive media. As described in U.S. Pat. No. 5,884,114, the cartridge could be a light tight cartridge in which photosensitive sheets are piled one on top of each other. When inserted into image-forming device 15, a feed mechanism that includes, for example, a feed roller 21a in image-forming device 15, working in combination with a mechanism in the cartridge, cooperate with each other to pull one sheet at a time from the cartridge into image-forming device 15 in a known manner. Although a cartridge type arrangement is shown, the present invention is not limited thereto. It is recognized that other methods of introducing media into to the image-forming device such as, for example, individual media feed or roll feed are applicable to the present invention.

Once inside image-forming device 15, photosensitive media travels along media path 19, and is transported by, for example, drive rollers 21 connected to, for example, a driving mechanism such as a motor. The photosensitive media will pass by an imaging member 25 in the form of an imaging head that could include a plurality of light emitting elements (LEDs) that are effective to expose a latent image on the photosensitive media based on image information. After the latent image is formed, the photosensitive media is conveyed past a processing assembly or a development member 27. Processing assembly 27 could be a pressure applicator or pressure assembly, wherein an image such as a color image is formed based on the image information by applying pressure to microcapsules having imaging material encapsulated therein to crush unhardened microcapsules. As discussed above, the pressure could be applied by way of spring-loaded balls, micro wheels, micro rollers, rolling pins, etc.

FIG. 1B schematically illustrates an example of a pressure applicator 270 for processing assembly 27 which can be used in the image-forming device of FIG. 1A. In the example of FIG. 1B, pressure applicator 270 is a crushing roller arrangement that provides a point contact on photosensitive medium 102. More specifically, pressure applicator 270 includes a support 45 that extends along a width-wise direction of photosensitive medium 102. Moveably mounted on support 45 is a crushing roller arrangement 49 that is adapted to move along the length of support 45, i.e., across the width of photosensitive medium 102. Crushing roller arrangement 49 is adapted to contact one side of photosensitive medium 102. A beam or roller type member 51 is positioned on an opposite side of photosensitive medium 102 and can be provided on a support or spring member 57. Beam or roller type member 51 is positioned so as to contact the opposite side of photosensitive medium 102 and is located opposite crushing roller arrangement 49. Beam or roller type member 51 and crushing roller arrangement 49 when in contact with photosensitive medium 102 on opposite sides provide a point contact on photosensitive medium 102. Crushing roller arrangement 49 is adapted to move along a width-wise direction of photosensitive material 102 so as to crush unhardened microcapsules and release coloring material. Further examples of pressure applicators or crushing members that can be used in the image-forming device of FIG. 1A are described in U.S. Pat. Nos. 6,483,575 and 6,229,558.

Within the context of the present invention, the imaging material comprises a coloring material (which is used to form images) or material for black and white media. After the formation of the image, the photosensitive media is conveyed past heater 29 (FIG. 1A) for fixing the image on the media. In a through-feed unit, the photosensitive media could thereafter be withdrawn through an exit 32. As a further option, image-forming device 15 can be a return unit in which the photosensitive media is conveyed or returned back to opening 17.

As previously discussed, conventional arrangements employ spring loaded micro-wheels or ball processing (point processing) to provide a pressure or crushing force to microcapsules of microencapsulated media. The traditional approach for crushing the microcapsules by way of a crushing force applied by balls, wheels or micro-rollers may provide for processing speeds which are in some instances not as fast as desired due to the fact that the development pitch of these arrangements are small, and processing velocity is limited to reasonable bi-directional travel rates. Furthermore, in the traditional ball-crushing arrangements, debris introduced into the printer can cause the ball or micro-wheel to drag the debris over the media to cause a scratching of the image and, thus, render the print unusable.

In order to provide for a higher throughput device, large rollers, which have a width that covers the width of the media, can be utilized. However, these large rollers tend to require high spring loading and may deflect under load. This could adversely affect the application of pressure on the media.

Also, as discussed above, media substrates prone to deformation under the pressure load for development (typically 100 MpA) can jam in the device or irreversibly deform thus rendering the print unusable. In addition, debris entering the processing nip between rollers can cause damage to the roller rendering the processing means unusable.

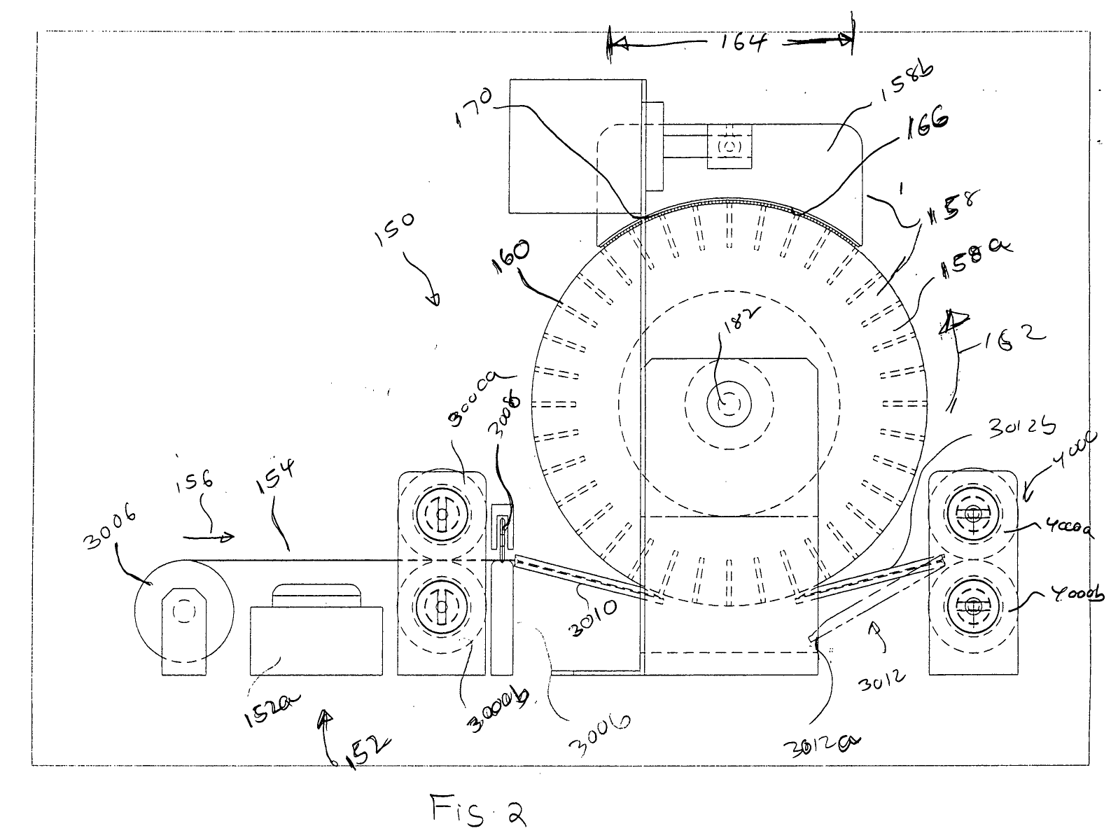

The present invention overcomes the above-noted drawbacks by providing for a compact image-forming device or brush/drum processing member as shown in FIG. 2. More specifically, the image-forming device 150 of the present invention includes a brush/drum processing member as illustrated in FIG. 2 which is effective to process microencapsulated media as described above, while at the same time providing for a smaller footprint.

As illustrated in FIG. 2, the image-forming device 150 includes an exposure section 152 having an exposure device 152a where a photosensitive medium 154 to be processed is exposed to form a latent image on the photosensitive medium 154. In order to facilitate the loading or transfer of the medium onto the drum processing member of the present invention, the media is preferably conveyed with the imaging side, and more particularly, the surface the included the microcapsules facing downward. In view of this, as shown in FIG. 2, the exposure device 152a is preferably located below the media path to expose the microcapsules located on the downward facing surface of the medium.

The medium can be a roll fed medium as shown as represented in FIG. 2 by roller 3006 that is adapted to convey medium 154 through exposure section 152 as shown. After exposure at exposure section 152, medium 154 is conveyed by a drive roller pair 3000a, 3000b to a brush/drum processing member 158.

As shown in FIG. 2, immediately downstream of drive roller pair 3000a, 3000b, a cutting arrangement 3006 having a cutting blade 3008 can be located. The blade 3008 is operable to cut the medium into individual cut sheets for delivery to brush/drum processing member 158 via a guide member or plate 3010. It is noted that the present invention is not limited to roll fed media and the cut sheets can be provided to the exposure section in a known manner for processing at the brush/drum processing member.

Therefore, the photosensitive medium 154 moves in a direction shown by the arrow 156 in FIG. 2, and is delivered to a brush/drum processing member 158 as shown in FIG. 2. The brush/drum processing member 158 includes a vacuum drum 158a attached to a vacuum source that applies a vacuum pressure to a plurality of apertures or air outlets 160 on drum 158a. The apertures or air outlets 160 open to an outer peripheral surface of the drum 158a as illustrated in FIG. 2.

Therefore, after exposure, the photosensitive media 154 is conveyed by drive roller pair 3000a, 3000b and guide member 3010 onto the outer peripheral surface of the drum 158a, in a manner in which the imaging surface (microcapsule side) of the media faces outward or away from the peripheral surface of the drum 158a. Accordingly, the lower surface of the photosensitive medium 154 that does not contain the microcapsules contacts the outer surface of the drum 158a in a manner where a vacuum force applied through the apertures 160 holds the photosensitive medium 154 on the surface of the drum 158a. In this way, only the side of the medium that does not contain the microcapsules comes into contact with the surface of the drum. Therefore, the microcapsules are not affected by the drum surface. Further, the applied vacuum does not affect the microcapsules.

The drum 158a can then be moved or rotated in the direction shown by arrow 162 by any known motor or gearing arrangement to convey media to a processing section 164. At processing section 164, brush/drum processing member 158 includes a pad member 158b that is positioned to face the outer surface of drum 158a. The pad member 158b includes a processing surface 166 that faces the outer surface of the drum 158b and has a radius of curvature that matches the radius of curvature of the drum 158a. A plurality of micro-members 170 are positioned on the processing surface 166 of pad member 158b so as to face the outer surface of drum 158a. In a preferred embodiment, the micro-members are hook or loop-like members that define or resemble a brush-like surface that forms a compliant and potentially non-uniform surface. This is effective to compensate for any imperfections in the media. It is noted that the micro-members 170 can be made of plastic or resin material.

Therefore, after the exposed media 154 is placed on the drum 158a by way of guide member 3010, the drum 158a is rotated in the direction illustrate by the arrow 162 to convey media 154 to processing section 164 at the area of pad member 158b. Since the media is placed on the drum 158a with the imaging side (the side with the microcapsules) facing outward, when the media is conveyed to the processing section by rotating the drum 158a, the imaging side of the media will face the processing surface 166 of the pad member 158b.

As also shown in FIG. 2, the arrangement of the present invention includes a an exit guide or plate member 3012 which is adapted to lead the processed media to an exit roller pair of preferably a post-heat roller arrangement which will be describe later. The exit guide member 3012 is movable between a first position 3012a where the guide member is away from the surface of the drum 158a. The exit guide member is located in the first position when the media is loaded on the drum from guide member 3010 and conveyed by way of the rotation of the drum in direction 162 to processing section 164. The first location of the exit guide member assures that the exit guide member does not interfere with the media while the media is being conveyed to media is being conveyed to the processing section and while the media is being processed. After processing is complete, exit guide member 3012 can be moved to position 3012b where it can receive the media after processing by way of the vacuum being turned off to release the media. The exit guide member 3012 in position 3012b can then lead the media to an exit roller pair or a post-heat roller arrangement.

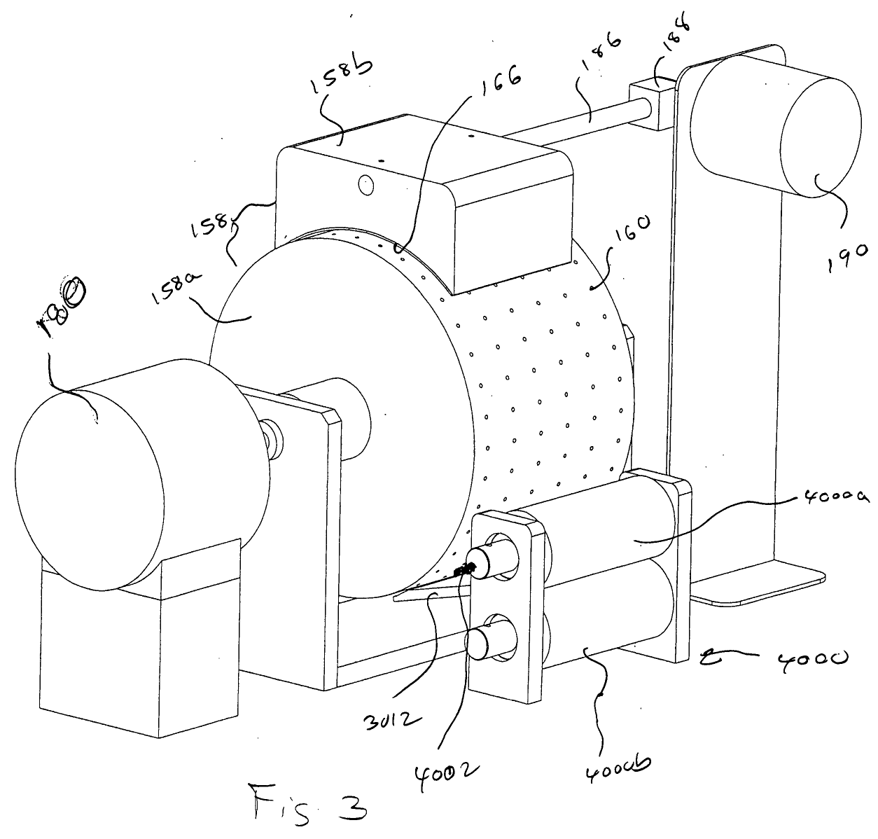

FIG. 3 is a perspective view of the image-forming device 150 and, specifically, brush/drum processing member 158 which illustrates the apertures 160 and the outer surface of drum 158a relative to the processing surface 166 of the pad member 158b. Also, FIG. 3 illustrates a motor 180 that can be used to rotate the drum 158a about a rotational axis 182 (FIG. 2) of the drum 158a.

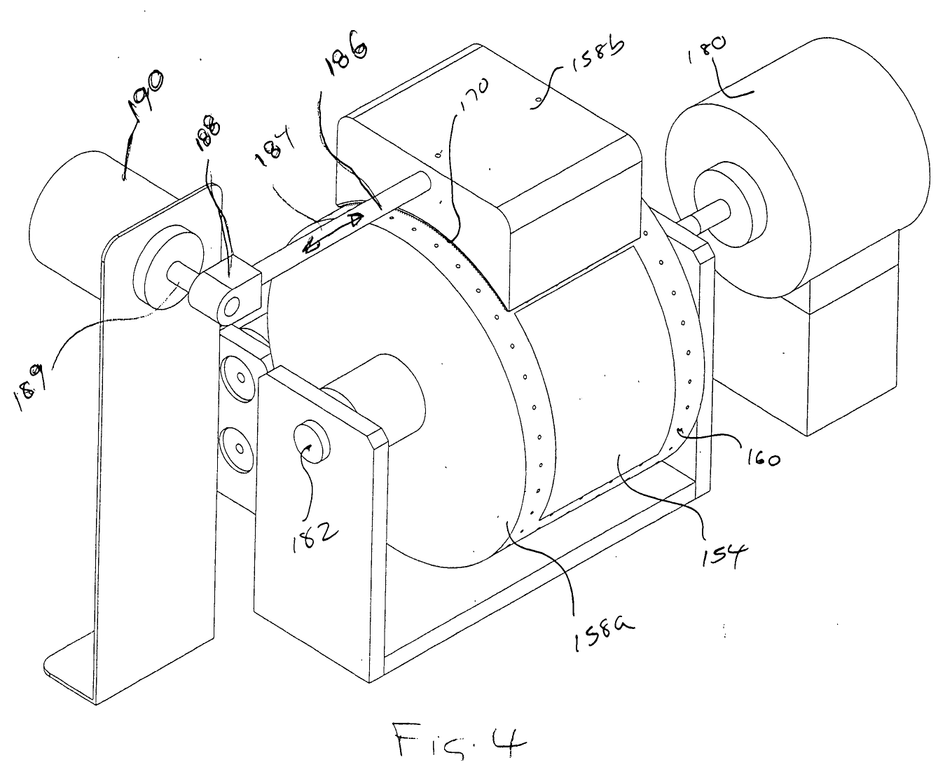

With reference to FIG. 4, the media 154 held on the drum 158a through a vacuum suction force is shown. In the example of FIG. 4, vacuum force has been applied to the interior of the drum 158a to hold the media 154 on the drum 158a. The drum 158a with the media 154 thereon is rotated in the direction of the arrow 162 so that the media is between the pad member 158b and the outer surface of the drum 158a. In this position, the micro-members 170 on the pad member 158b contact the imaging or top surface of the media. Also, the pad member 158b can be oscillated or moved in the direction illustrated by arrow 184 which is a direction that is parallel to the rotational axis 182 of the drum 158a. This movement is effective to process the imaging surface of the media and, more specifically, the micro-members and develop the latent image on the media

For moving or oscillating pad member 158b, as illustrated in FIG. 4, the pad member 158b can be operationally attached to a shaft 186 attached to a rotating eccentric member 188. The rotating eccentric member 188 is attached to a shaft 189 and motor 190. A rotation of the eccentric member 188 by the motor 190 causes an oscillating motion of the pad member in the direction illustrated by the arrow 184, which is a direction that is parallel to the rotational axis 182 of the vacuum drum 158a.

With the arrangement of the present invention, when the drum 1158a is rotated to convey the media 154 to an area below the processing surface of the pad member 158b, the pad member can be oscillated. This causes the micro-members or hook- or loop-like member that resemble a brush-like surface to be brought into contact with the imaging or top surface of the media. This contact while the pad member is oscillated provides for a shearing-like motion that essentially is converted to a pressure on the media to cause a rupture of the non-hardened microcapsules to release coloring material. This causes a development of the image as described in the background and assures a complete processing of the entire surface of the media.

This arrangement is advantageous for processing media such as disclosed in co-pending application U.S. Publication No. 2005/0084783, since the plastic or resilient loop or a hook-like members provide a sufficient force to rupture the capsules, while a random positioning and height of the loop or a hook-like members allows for uniform development of non-uniform media thicknesses. Also, with the use of the pad member and micro-members or brush as described, processing can be restricted to the microcapsules and any deformation or patterning caused by density differences in the support sheet and read out in the development of the media due to the resulting differential pressure is of no consequence.

In a feature of the present invention, in order to ensure a rapid and complete processing of the media, the vacuum drum with the media held thereon is rotated while the pad member is oscillated.

In a still further feature of the present invention, the processing also can be varied since the drum and oscillating member be moved at various speeds.

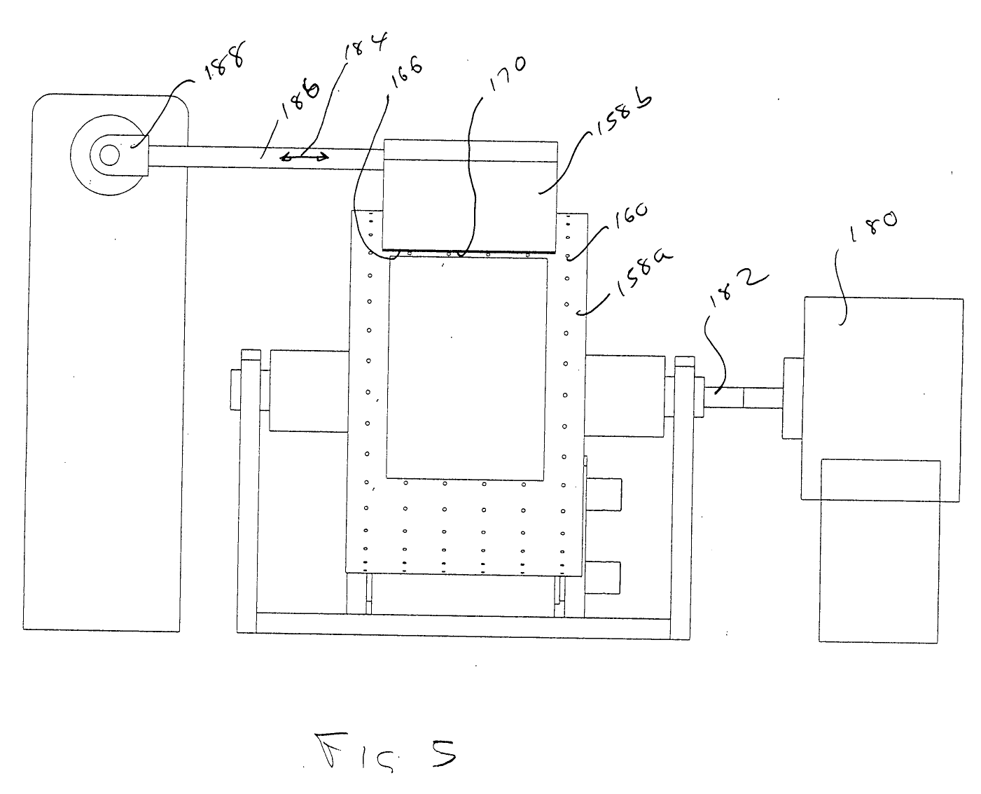

FIG. 5 is a further view of the pad member 158b and shaft 186 as well as the eccentric member 188 that is utilized to oscillate the pad member in a direction that is parallel to the rotational direction of the drum.

After the media is processed, the vacuum drum is rotated as necessary in direction 162 to bring the processed media to exit guide member 3012 as shown in FIG. 2. As indicated above, after processing exit guide member 3012 is located in position 3012b. Therefore, as the leading portion and subsequent trailing portions of the processed media pass the tip of the exit guide member 3012 in position 3012b, the vacuum is released to permit the media to settle onto the exit guide member 3012. It is noted that the vacuum to the apertures can be control through the use of known solenoids and diverters to selectively activate or deactivate selected apertures. Therefore, as apertures at the leading end of the media are deactivated to release the leading end of the media onto the exit guide member 3012, the trailing end of the media can be driven by the rotating drum and the still activated apertures until the front end of the media is located at a post-heat roller arrangement 4000, and more particularly at a nip portion of a pair of a post-heat rollers 4000a, 4000b. Thereafter, the vacuum at the trailing end of the media can be released and the driving rollers are utilized to drive the media between the post heat rollers 4000a, 4000b. The pair of post heat rollers 4000a, 4000b are adapted to heat the processed media and fix the image on the media, and thereafter, drive the media in a known manner to an outlet.

With regard to the post-heat roller arrangement, it is preferable that one of the rollers 4000a, 4000b be heated through the use of, for example, a thermocouple, so as to create heat at the surface of the one roller 4000a, 4000b, that is applied to the media as it passes between the rollers. This causes the image to be fixed and further permits the driving of the media to an outlet of the device.

The present invention therefore provides for an arrangement that can reduce processing time since the entire media can be in contact with the processing surface and more specifically, the micro-members, (i.e. the hook and loop members which resemble a brush) at once.

The brush/drum processor of the present invention permits the use of low cost media since the processing is restricted to the microcapsules and any deformation or patterning will be reduced.

The invention has been described in detail with particular reference to certain preferred embodiments thereof, but it will be understood that variations and modifications can be effected within the spirit and scope of the invention.

1. An imaging forming device comprising:
an imaging member adapted to expose a photosensitive medium to form a latent image on the photosensitive medium, the photosensitive medium comprising a plurality of microcapsules which encapsulate imaging material; and
a processing member adapted to develop the latent image, said processing member comprising:
a rotatable vacuum drum having an outer surface adapted to receive said exposed photosensitive medium, said outer surface of said drum comprising a plurality of apertures for a passage of a vacuum force there-through to hold the medium on the outer surface of the drum during processing; and
a pad member having a processing surface that faces the outer surface of the vacuum drum, said processing surface of said pad member comprising a plurality of micro-members that are adapted to contact a surface of the photosensitive medium as the photosensitive medium held on the outer surface of said drum by the vacuum force is conveyed by rotation of the vacuum drum to said processing surface of the pad member.

2. An image forming device according to claim 1, wherein said pad member is adapted to move in a direction parallel to a rotational axis of said drum when said photosensitive medium is conveyed to said processing surface, such that said micro-members on the processing surface of the drum contact the surface of the photosensitive medium with a force that is sufficient to release imaging material from said microcapsules.

3. An image forming device according to claim 1, wherein said micro-members are hook or loop like members which extend from the processing surface of the pad member.

4. An image forming device according to claim 1, further comprising a pair of drive rollers adapted to convey said photosensitive medium onto the outer surface of the vacuum drum.

5. An image forming device according to claim 1, further comprising a pair of post heat rollers adapted to receive the developed photosensitive medium from the outer surface of said vacuum drum.

6. An image forming method comprising:
exposing a photosensitive medium comprising a plurality of microcapsules which encapsulate imaging material to form a latent image;
conveying the medium onto an outer surface of a processing drum, said outer surface of the processing drum comprising a plurality of apertures;
applying a vacuum force to said processing drum to create a suction force through said apertures and hold said medium on the outer surface of the processing drum; and
moving said processing drum to convey the medium to a processing pad having a processing surface that faces the outer surface of the processing drum, said processing surface of said processing pad comprising a plurality of micro-members that are adapted to contact a surface of said medium when the medium is conveyed to the processing pad.

7. An image forming method according to claim 6, further comprising:
moving the processing pad when the medium is conveyed to the processing pad to cause said micro-members to contact the surface of the photosensitive medium with a force that is sufficient to release imaging material from said microcapsules.

8. An image forming method according to claim 7, wherein said step of moving the processing pad comprises oscillating the processing pad in a direction that is parallel to a rotational axis of said processing drum.

9. An image forming method according to claim 6, wherein said micro-members are hook and loop like members.

10. An imaging forming device comprising:
a processing member adapted to develop a latent image on an exposed photosensitive medium, the photosensitive medium comprising a plurality of microcapsules that encapsulate imaging material, said processing member comprising a vacuum drum adapted to hold said exposed photosensitive medium thereon through a vacuum force, and a pad member that faces the vacuum drum, said pad member comprising a plurality of micro-members that are adapted to contact a surface of the photosensitive medium with a force that is sufficient to release imaging material from said microcapsules.

11. An image forming device according to claim 10, wherein said micro-members are hook or loop like members that extend from the pad member.

12. An image forming method comprising:
placing an exposed photosensitive medium onto a surface of a processing drum, said photosensitive medium comprising microcapsules that encapsulate imaging material;
applying a vacuum force to said processing drum to hold said medium on the surface of the processing drum; and
contacting a surface of said photosensitive medium with micro-members that extend from a pad member with a force sufficient to release the imaging material from said microcapsules.

13. An image forming method according to claim 12, wherein said processing drum is rotatatable.

14. An image forming method according to claim 13, wherein said pad member is movable in a direction that is parallel to a rotational axis of said processing drum.

15. An image forming method according to claim 12, wherein said micro-members are hook and loop members.
